(19) United States
(12) Patent Application Publication
(10) Pub. No.: US 2014/0086018 A1
(43) Pub. Date: Mar. 27, 2014

(54) SOUNDWAVE TRANSMISSION INSTALLATION METHOD

(71) Applicant: EDIMAX TECHNOLOGY CO., LTD., New Taipei City (TW)

(72) Inventors: JYU-GWANG CHI, TAOYUAN COUNTY (TW); YI-MING CHIN, TAIPEI CITY (TW)

(73) Assignee: EDIMAX TECHNOLOGY CO., LTD., NEW TAIPEI CITY (TW)

(21) Appl. No.: 13/795,079

(22) Filed: Mar. 12, 2013

(30) Foreign Application Priority Data
Sep. 21, 2012 (TW) 101134680

(51) Int. Cl. G08C 23/02

(52) U.S. Cl. CPC G08C 23/02
USPC 367/197

(57) ABSTRACT

A soundwave transmission installation method is an actuation procedure in which one system connects to and installs at least one embedded second system. The method consists of: activating the second system that is required to be installed; enabling the second system to wait for a notification signal transmitted from the first system, wherein the notification signal is in sound wave format and contains the setting data for initializing installation; and executing an installation procedure based upon setting data when the second system receives the notification signal such that installation is completed, and a designated system is automatically connected.

### CROSS-REFERENCE TO RELATED APPLICATIONS

This non-provisional application claims priority under 35 U.S.C. §119(a) on Patent Application No(s). 101134680 filed in Taiwan, R.O.C. on Sep. 21, 2012, the entire contents of which are hereby incorporated by reference.

### BACKGROUND OF THE INVENTION

1. Field of the Invention

This invention falls within the technical field of embedded system installation architecture, and more particularly of sound wave transmission installation method. It allows information to be transmitted between two system terminals for purposes of either installation or settings modification.

2. Description of Related Technology

In the past, when users wanted to connect to and control an embedded system such as a webcam or a network printer through wired or wireless network, they had to first install interface software onto their personal computer. Then, through this interface software, serial numbers, password, and network configurations had to be inputted, and parameters such as the IP address, sub-network mask, and DNS (domain name system) or communication ports had to be set. The cumbersome nature of these configuration procedures caused problems for users, thus detracting from the appeal of the technology. For this reason, the convention arose of equipping host devices with a tag and a barcode to facilitate installation and connection. As shown in FIG. 1, host device 1 can be connected to image capturing device 2 through a network to transmit image streaming data. Image capturing device 2 has two-dimensional barcode tag 20 containing information on the device serial number, brand code, product model number, and password. Host device 1 has data exchange interface module 10. control module 11, storage module 12 and connection module 13. Data exchange interface module 10 is externally connected to tag scanner 100, whose purpose is to scan tag 20, thus allowing data exchange interface module 10 to wirelessly read mentioned information and transmit information to control module 11 for depositing in storage module 12. And when host device 1 obtains the beacon packet broadcasted by image capturing device 2 and receives the connection request, this triggers control module 11 to compare the beacon packet with the information of tag 20 stored in storage module 11. The connection is then established through the beacon packet.

Further, host device 1 can be a smart phone that automatically connects to the embedded system of image capturing device 2 by scanning the two dimensional barcode, in which case the installation and settings data are continuously transmitted by the application program installed in the mobile phone during installation or settings modification. However, the two dimensional barcode is a read-only type tag, storing the default settings of the device, and is unable to store settings information modified after the fact. Consequentially, the user is stuck with the cumbersome and inconvenient task of having to reconfigure the settings with every update or reinstallation.

How do we improve the currently read-only barcode such that its stored information can be updated without recourse to personal computers or prior communications pairing? Such is the problem that this invention aims to solve.

### SUMMARY OF THE INVENTION

In view of the shortcomings prior technologies, the developers of the present invention conducted extensive research and experiments based on years of experience in the related industry, and finally developed a soundwave transmission installation method whose principle objective is to simplify the operational procedures of system installation, settings modification and updates by using sound waves to transmit data, with wide applications for the embedded systems found in webcams or routers.

As outlined in the stated objective, the soundwave transmission installation method is an actuation procedure in which one system connects to and installs at least one second system, where the second system is an embedded system. The method comprises the following steps: said second system requiring installation is activated; the second system waits for a notification signal transmitted from the first system, which is in the format of a sound wave that contains setting data for initial installation; when the second system receives the notification signal, executing installation procedure based on the setting data to complete system setting and establish the connection with the designated system.

Part of this procedure involves the first system transmitting a sound wave signal instantly initiating installation on the second system within a certain radius. The setting data furthermore contains connection data for a third system such that the second system, upon the completion of its installation, automatically connects either back to the first system and or to an additional third system. Thus, practicality is improved, as the second system can automatically connect any designated system.

In brief, the invention utilizes sound waves to transmit between two systems various sorts of settings data, including the device serial number, brand code, product model number, access password, network address, SSID (service set identifier, SSID), and environmental parameters, so as to simplify installation and updates such that the goal of zero configuration can be achieved, all the while improving convenience and user-friendliness.

### BRIEF DESCRIPTION OF THE DRAWINGS

FIG. 1 is a block diagram of a conventional host device that utilizes tags and barcodes performing installation and connection;

FIG. 2 is a flowchart of the method according to a preferred embodiment of the invention;

FIG. 3 is a schematic diagram for utilization according to a preferred embodiment of the invention;

FIG. 4 is a flowchart of another method according to a preferred embodiment of the invention;

FIG. 5 is a schematic diagram for another utilization according to a preferred embodiment of the invention;

FIG. 6 is another flowchart of the method according to a preferred embodiment of the invention;

FIG. 7 is another schematic diagram for utilization according to a preferred embodiment of the invention;

FIG. 8A and 8B is yet another flowchart of the method according to a preferred embodiment of the invention; and

FIG. 9 is yet another schematic diagram for utilization according to a preferred embodiment of the invention.

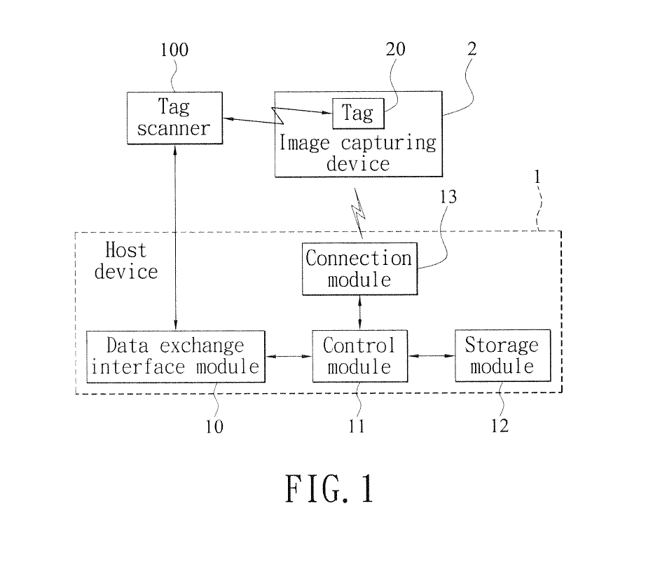

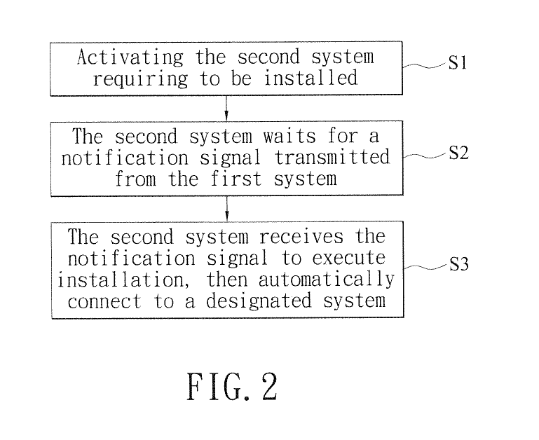

### DETAILED DESCRIPTION OF THE PREFERRED EMBODIMENTS

The technical content of the present invention will become apparent by the following detailed description and accompanying illustration of its various embodiments.

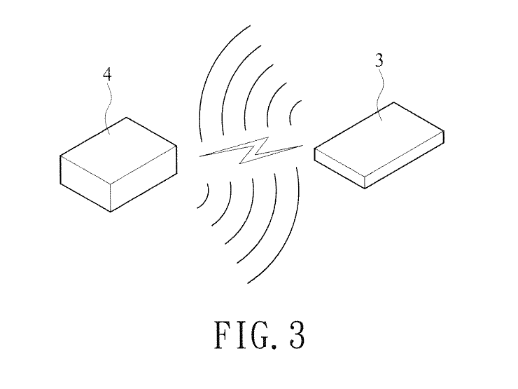

In FIG, 2 and FIG. 3, a flowchart of the method and a schematic diagram for utilization according to a preferred embodiment of the invention are respectively depicted. As shown in the figures, the soundwave transmission installation method is an actuation procedure in which a first system 3 connects and installs at least one second system 4. The first system 3 can be smartphone, tablet computer or portable computer, and the second system 4 is an embedded system as IP cam or router. The soundwave transmission installation method utilizes sound signals to package data and information to transmit between two systems for executing actions of system installation or settings modification. The steps of this procedure are as following:

First, in step S2, the second system 4, needing to be installed, is activated. The second system 4 may be activated, for example, by directly pressing buttons. Alternatively, the first system 3 could activate the second system 4 by such possible means as Wi-Fi protected setup (WPS) or sound wave-transmitted trigger signal.

In step S3, the second system 4 waits for a notification signal transmitted from the first system 3, which is in the format of a sound wave that contains setting data for initial installation. The setting data includes the device serial number, brand code, product model number, access password, network address, SSID, and environmental parameters.

In step S4, when the second system 4 receives the notification signal, executing installation procedure based on the setting data to complete system setting and establish the connection with the designated system. such as the first system 3. Thus, the second system 4 is remotely controlled by the first system 3.

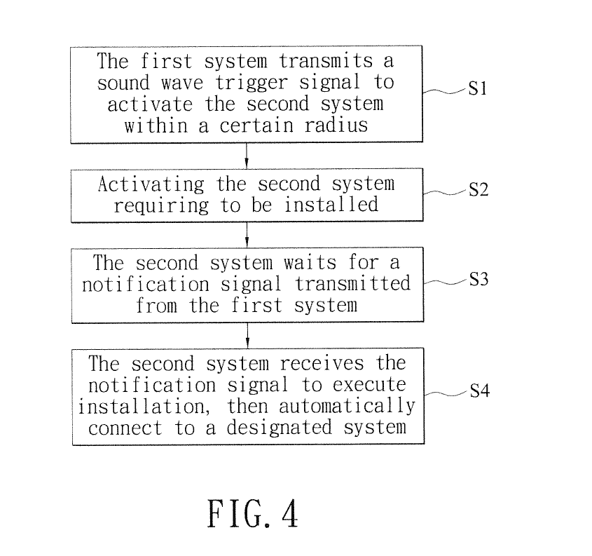

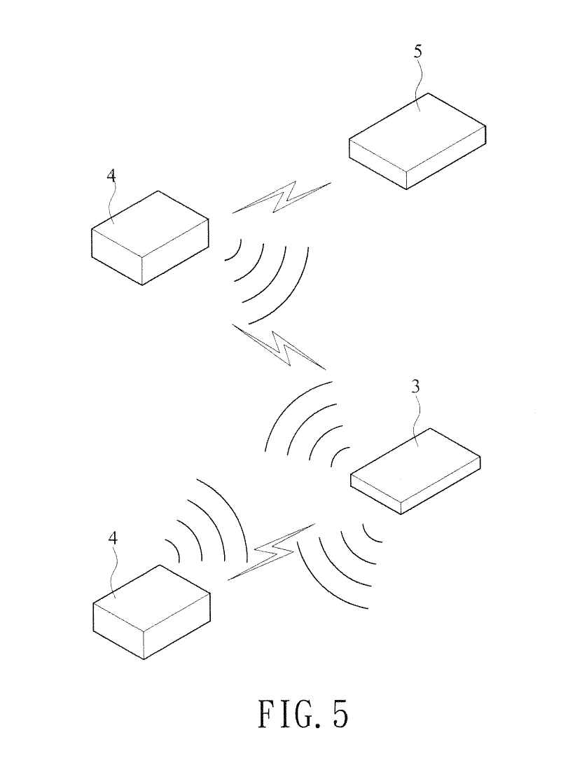

FIG. 4 and FIG. 5 respectively depict a schematic diagram for utilization and a flowchart of another method according to a preferred embodiment. As shown in the figures, the second system 4 can be configured for multiple uses, and the setting data contains connection information not only for the first system 3, but also for the third system 5, including network addresses, device data and access controls for electronic devices as personal computers, terminal data servers, webcams or routers. Further, setting data further has connection data of the third system 5. Accordingly, in step S4, the second system 4 is automatically connected to at least one of the first system 3 and the third system 5 after completing installation, thereby flexibly regulating system architecture.

In the embodiment, the foregoing step S2 further has a step S1: the first system 3 transmits a sound wave trigger signal to activate second system 4 within a certain signal radius.

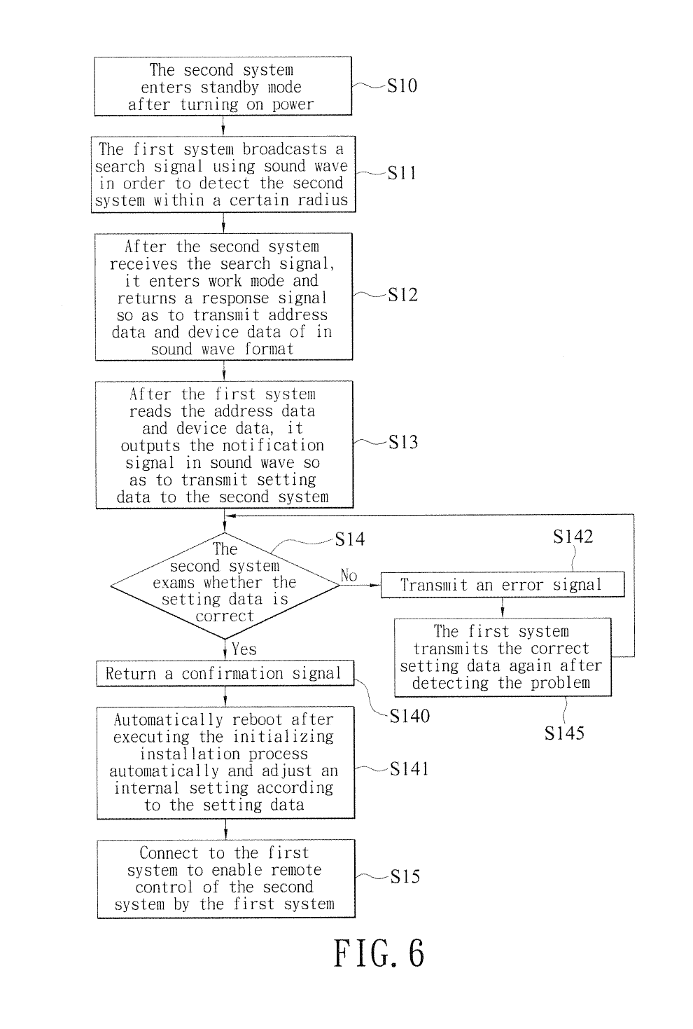

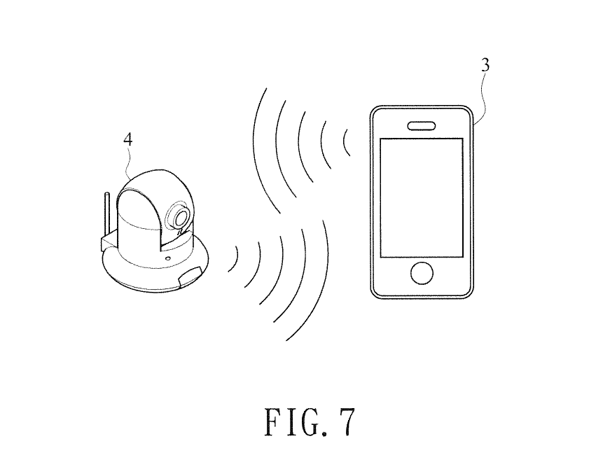

An example which the first system 3 being a mobile phone with an installed application program and the second system 4 being an IP Cam is shown in FIGS. 6 and 7. After the IP Cam power is turned on and the second system 4 enters a standby mode in step S10, the application program is activated in step S11 such that the first system 3 drives a mobile phone speaker so as to broadcast a search signal using sound wave with frequency above 14 kHz in order to detect the second system 4 within the certain radius. After the second system 4 within the certain radius receives the search signal through a microphone or other sound receiving device and is driven and enters a work mode in step S12, it returns a response signal through the speaker or other audio device so as to transmit an address data and a device data in sound wave format to the first system 3. In step S13 after the first system 3 reads a real-time device data of the second system 4, it outputs a notification signal in sound wave according to the address data and the device data so as to transmit an installation micro procedure and the setting data in sound wave format to the second system 4 for requesting installation connection. In step S14, after the second system 4 receives the aforementioned data, it exams whether the installation micro procedure and the setting data is correct. If yes, a confirmation signal is returned using sound wave in step S140; meanwhile in step S141, the installation micro procedure is automatically executed for performing initializing installation process; and internal setting content is adjusted according to the setting data in order to complete installation setting. Next, step S15 is performed after automatic reboot, in which automatic connection to the first system 3 is established according to the setting data; thus, the user can control IP Cam immediately via mobile phone remotely. On the other hand, if the second system 4 founds problem within the setting data or the installation micro procedure after the examination, an error signal is sent to the first system 3 in step S142; and the first system 3 is asked to send the correct installation micro procedure and setting data again in step S143 after detecting the problem.

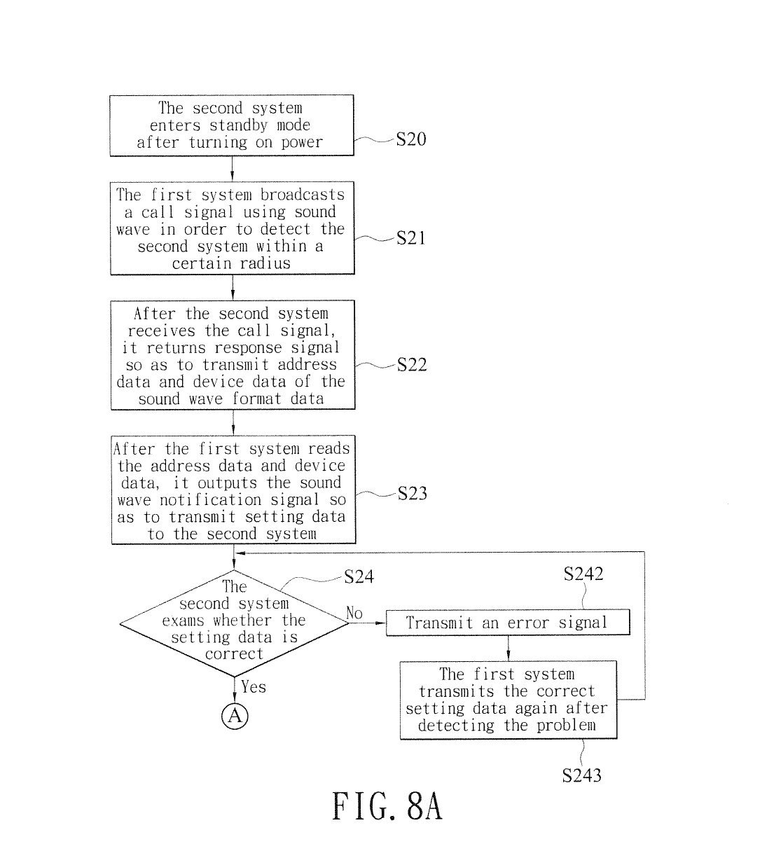

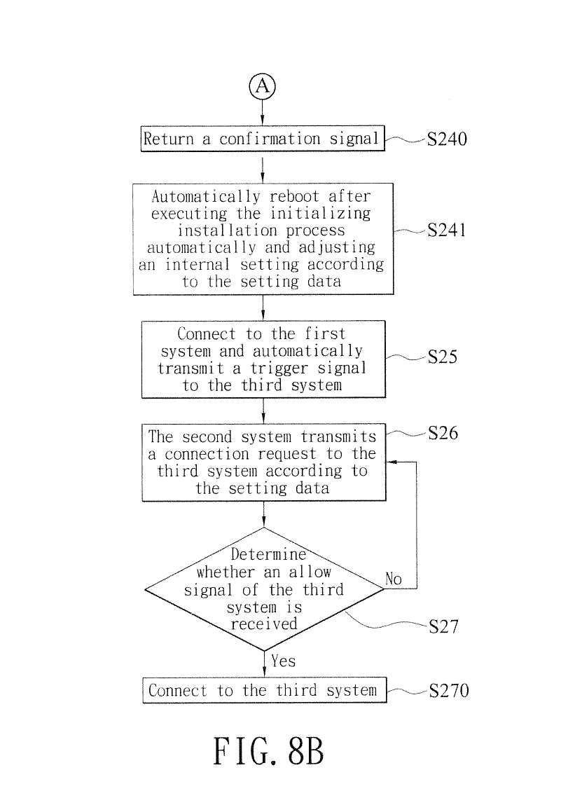

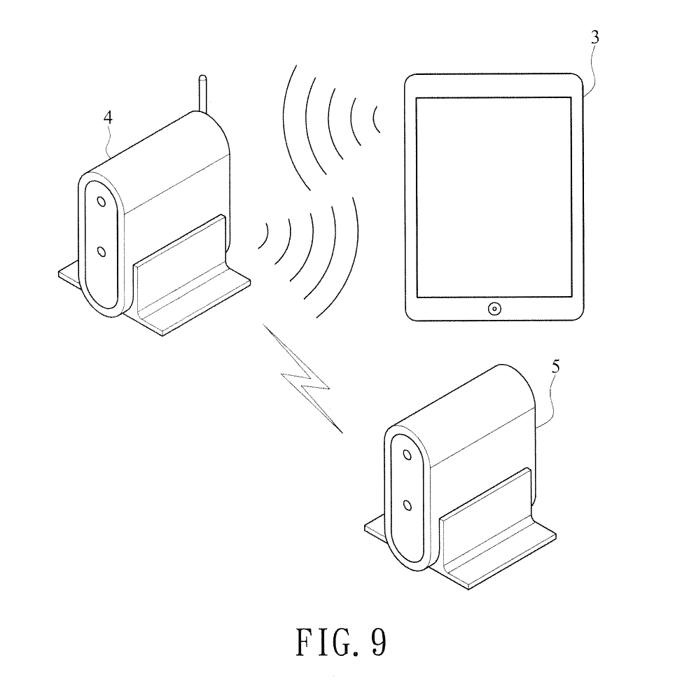

Furthermore, an example in which the first system 3 being a tablet computer, the second system 4 being a wireless internet router, and the third system 5 being an ISP ADSL/Cable modem is shown in FIGS. 8 and 9. After the power of the wireless internet router is turned on and the second system 4 enters a standby mode in step S20, the application program installed in the tablet computer is activated in step S21; the application program is used for allowing the first system 3 to trigger a speaker and broadcast a call signal so as to call the second system 4 within the certain radius and trigger the second system 4 to enter a work mode. After the second system 4 within the certain radius receives the call signal via a sound receiving device in step S22, it returns a response signal through a sound device so as to transmit an address data and a device data in sound wave format to the first system 3. In step S23, after the first system 3 reads the address data and the device data, it displays the device data of the second system 4 in the application program, and facilitates the user to view or edit; and the first system 3 outputs a notification signal in sound wave according to the address data and the device data so as to transmit an installation micro procedure and the setting data in sound wave format to the second system 4 for requesting installation connection. The setting data simultaneously contains data such as the network address, device data, and access controls of the first system 3 and the third system 5. In step S24, after the second system 4 receives the aforementioned data, it exams whether the installation micro procedure and the setting data are correct; if yes, sound wave is used for returning a confirmation signal in step S240; meanwhile in step S241, the installation micro procedure is automatically executed for performing initializing installation process; and an internal setting content is adjusted according to the setting data in order to complete installation setting. Next, step S25 is performed after automatic reboot, in which the automatic connection to the first system 3 is established according to the setting data; thus, the user can control wireless network router immediately via tablet computer remotely; in the meantime, the second system 4 transmits a trigger signal to the third system 5 via network automatically. The second system 4 then transmits a connection request to the third system 5 according to the setting data via network in step S26; and step S27 is executed, in which a determination of whether a permission signal returned from the third system 5 is received; if yes, in step S270, a connection with the third system 5 is established via network.

On the other hand, if the second system 4 finds problem within the setting data or the installation micro procedure after the examination, then perform step S242, in which an error signal is sent to the first system 3 requesting the first system 3 to send the correct installation micro procedure and setting data again after detecting the problem in step S243.

While the means of specific embodiments in the present invention has been described by reference drawings, numerous modifications and variations could be made thereto by those skilled in the art without departing from the scope and spirit of the invention set forth in the claims. The modifications and variations should limited in range by the specification of the present invention.

What is claimed is:

1. A soundwave transmission installation method that takes the form of an actuation procedure of connecting a first system and installing and imputing settings on at least a second system, where the second system is an embedding system. The soundwave transmission installation method comprises the following steps:
activating the second system that is required to be installed;
enabling the second system to wait for a notification signal transmitted from the first system, where the notification signal is in sound wave format and has setting data for initial installation;
executing a installation procedure based on setting data when the second system receives the notification signal such that a designated system is automatically connected upon completion of the installation.

2. The soundwave transmission installation method of claim 1, wherein the first system transmits a sound wave trigger signal to activate and install the second system within a certain radius receiving the trigger signal.

3. The soundwave transmission installation method of claim 1, wherein said setting data further comprises connection data of a third system such that the second system automatically connects at least one of the first system and the third system after completing installation.
